(19) United States
(12) Patent Application Publication
(10) Pub. No.: US 2014/0025746 A1
(43) Pub. Date: Jan. 23, 2014

(54) APPARATUS AND METHOD FOR MANAGING USER INFORMATION

(71) Applicant: Samsung Electronics Co., Ltd, Gyeonggi-do (KR)

(72) Inventors: In-Jong Rhee, Gyeonggi-do (KR); Kwang-Sub Son, Gyeonggi-do (KR)

(73) Assignee: Samsung Electronics Co., Ltd, Gyeonggi-do (KR)

(21) Appl. No.: 13/948,984

(22) Filed: Jul. 23, 2013

(30) Foreign Application Priority Data
Jul. 23, 2012 (KR) 10-2012-0079805

(51) Int. Cl. H04L 29/08

(52) U.S. Cl. CPC H04L 67/306
USPC 709/204

(57) ABSTRACT

A method of operating a server that manages first user information using a first terminal and second user information using a second terminal is provided. The method of operating the server according to the present disclosure includes receiving a request for additional information that requests provision of additional information which is not stored in the first terminal among the second user information, transmitting an inquiry concerning, whether to provide the additional information from the first user, receiving a response to the inquiry corresponding to the inquiry, and determining whether to transmit the additional information stored in the server to the first terminal, based on the response to the inquiry.

### CROSS-REFERENCE TO RELATED APPLICATION(S) AND CLAIM OF PRIORITY

The present application is related to and claims the priority under 35 U.S.C. §119(a) to Korean Application Serial No. 10-2012-0079805, which was filed in the Korean Intellectual Property Office on Jul. 23, 2012, the entire content of which is hereby incorporated by reference.

### TECHNICAL FIELD

The present disclosure relates generally to a server and a terminal that manage user information, and controlling methods thereof, and specifically to a server and a terminal that effectively manage transmission and reception of information between users registered to a specific service.

### BACKGROUND

Recently, an SNS (social network service) has been actively and widely spread. An SNS may mean an online platform that enables free communication among users and information sharing. A conventional SNS is generally a web-based service. However, other than the web-based service, a service that enables communication among users using a text message or an e-mail may be named an SNS.

Especially, in recent times, as smart phones are distributed rapidly, accessibility to the Web has been increased. Accordingly, the user is capable of using an SNS without spatial restriction. As a result, the development and the release of SNS-related applications are actively in progress.

General SNS-related applications request user information at the time of registration. The user inputs user information to be registered to an SNS. An SNS management server may store or manage user information.

Meanwhile, among users, not the entire but a part of user information may be shared. For example, a user A knows the phone number of a user B, but does not know an e-mail address of the user B. In this case, the user A should directly inquire about the e-mail address to the user B. Further, inconveniently, the user B must comprehend the inquiry, write his or her e-mail address, and reply to the user A. Accordingly, it is requested to develop a technique for more easily sharing information among users.

### SUMMARY

To address the above-discussed deficiencies of the prior art, it is a primary object of the present disclosure to provide a server a terminal, and a method capable of providing user information managed by the server to another user.

In order to achieve the above, an aspect of the present disclosure is to provide a method of controlling a server that manages first user information using a first terminal and second user information using a second terminal. The method includes receiving an additional information provision request message that requests to provide additional information which is not stored in the first terminal among the second user information, transmitting an inquiry concerning whether to provide the additional information from the first user, receiving a response to the inquiry, and determining whether to transmit the additional information stored in the server to the first terminal, based on the response to the inquiry.

Meanwhile, another aspect of the present disclosure is to provide a method of controlling a first terminal registered to an information management service provided by a server. The method includes transmitting an additional information provision request message that requests to provide additional information which is not stored in the first terminal among the second user information; and receiving the additional information stored in the server from the server.

Meanwhile, another aspect of the present disclosure is to provide a method of controlling a second terminal registered to an information management service provided by a server. The method includes receiving, an inquiry concerning whether to provide the first user with additional information which is not stored in the first terminal among the second user information, from the server; receiving an input in response to the inquiry from the user, and transmitting the response to the inquiry to the server.

Meanwhile, another aspect of the present disclosure is to provide a method of controlling a server that manages first user information using a first terminal and second user information using a second terminal. The method includes receiving a response to the inquiry about whether to provide the first terminal with additional information that is not stored in the first terminal among the second user information, from the second terminal, and determining whether to transmit the additional information stored in the server to the first terminal based on the response to the inquiry.

Meanwhile, another aspect of the present disclosure is to provide a server that manages first user information using a first terminal and second user information using a second terminal. The server includes a storage unit that stores the first user information and the second user information; a communication unit that receives an additional information provision request message that requests to provide additional information which is not stored in the first terminal among the second user information, from the first terminal; and a controller that generates an inquiry concerning whether to provide the additional information from the first user and controls the communication unit to transmit the additional information to the second terminal, wherein the communication unit receives a response to the inquiry corresponding to The inquiry, and

the controller determines whether to transmit the additional information stored in the storage unit to the first terminal based on the response to the inquiry.

Another aspect of the present disclosure is to provide a first terminal registered to an information management service provided by a server. The :first terminal includes a controller that generates an additional information provision request message that requests to provide additional information which is not stored in the first terminal among the second user information; and a communication unit that transmits the additional information provision request message and receives the additional information stored in the server from the server.

Another aspect of the present disclosure is to provide a second terminal registered to an information management service provided by a server. The second terminal includes a communication unit that receives an inquiry concerning whether to provide the first user with additional information which is not stored in the first terminal among the second user information, from the server, an input unit that receives an input of the additional information provision approval/refusal from the user, and a controller that generates a response to the inquiry, based on the received additional information provision approval/refusal, and controls the communication unit to transmit the response to the inquiry to the server.

Another aspect of the present disclosure is to provide a server that manages first user information using a first terminal and second user information using a second terminal. The server includes a communication unit that receives a response to the inquiry about whether to provide the first terminal with additional information that is not stored in the first terminal among the second user information, from the second terminal, and a controller that determines whether to transmit the additional information stored in the server to the first terminal based on the response to the inquiry.

According to various embodiments of the present disclosure, a server and a terminal capable of providing user information managed by the server to another user under approval, and methods thereof are provided. According to various embodiments of the present disclosure, an effect of easily transmitting and receiving information among users without writing items input by a user may be obtained. Especially, since approval procedures should be performed prior to the provision of the specific user information, a user information security effect may be obtained..

Before undertaking the DETAILED DESCRIPTION OF THE DISCLOSURE below, it may be advantageous to set forth definitions of certain words and phrases used throughout this patent document: the terms “include” and “comprise,” as well as derivatives thereof, mean inclusion without limitation; the term “or,” is inclusive, meaning and/or: the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating transmission and reception of information between a server and a terminal according to an embodiment of the present disclosure;

FIG. 2 is a detailed block diagram of FIG. 1;

FIGS. 3A to 3C illustrate signal flow diagrams illustrating operations of a server and terminals of the present disclosure;

FIG. 4A is a flowchart illustrating an operation of a server of the present disclosure;

FIGS. 4B and 4C are flowcharts illustrating operations of a terminal according to the present disclosure;

FIGS. 5A to 5E are diagrams illustrating concepts of a terminal according to an embodiment of the present disclosure;

FIG. 6 is a signal flow diagram illustrating operations of the server and the terminals of the present disclosure;

FIGS. 7A to 7D are diagrams illustrating concepts of the terminal according to an embodiment of the present disclosure; and

FIGS. 8 to 10 are block diagrams illustrating reception and transmission of information between a server and terminals according to various embodiments of the present disclosure.

### DETAILED DESCRIPTION

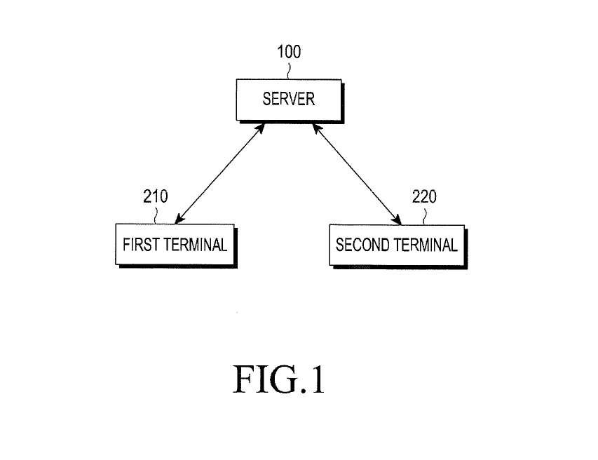

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, various embodiments of the present disclosure will be described with reference to the accompanying drawings. In the drawings, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

FIG. 1 is a block diagram illustrating transmission and reception of information between a server and a terminal according to an embodiment of the present disclosure.

As illustrated in FIG. 1, a server 100 may transmit and receive information to and from the first terminal 210. Further, the server 100 may transmit and receive information to and from the second terminal 220. Here, it is assumed that the first terminal 210 and the second terminal 220 store a specific application. Further, a first user who is a user of the first terminal 210 and a second user who is a user of the second terminal 220 are registered to the specific application.

For example, the first user may provide first user information at the time of being registered to the specific application. The first user information may provide, for example, a phone number applied to the first terminal 210, a photograph, an e-mail address, introduction information, first user preference information, address information, homepage information of the first user, private information of the first user, or the like.

The server 100 may provide the first user 210 with a UI (User Interface) inquiring the user information when the first user requests the registration. The server 100 can receive and store the first user information input to the UI by the first user. Further, the server 100 can receive information stored in the first terminal 210. For example, the server 100 can inquire whether to provide the first user information from the first terminal 210 or not. When the first user approves to provide information, the first terminal 210 can transmit the first user information, for example, address information or the like, to the server 100.

The server 100 can receive and manage first user information and second user information. For example, the server 100 can update the first and second user information at the time of the generation of periodic or specific events.

Meanwhile, the server 100 can relay messages between the first terminal 210 and the second terminal 220. For example, if the first user desires to transmit a certain message to the second user, the first user controls the first terminal 210 and writes a message to be transmitted to the second user. The first terminal 210 transmits the input message to the server 100. The server 100 can transmit the received message to the second terminal 220. The message transmitted from the first terminal 210 to the server 100 can include, for example, the identification of the second terminal 220 and the contents of the message.

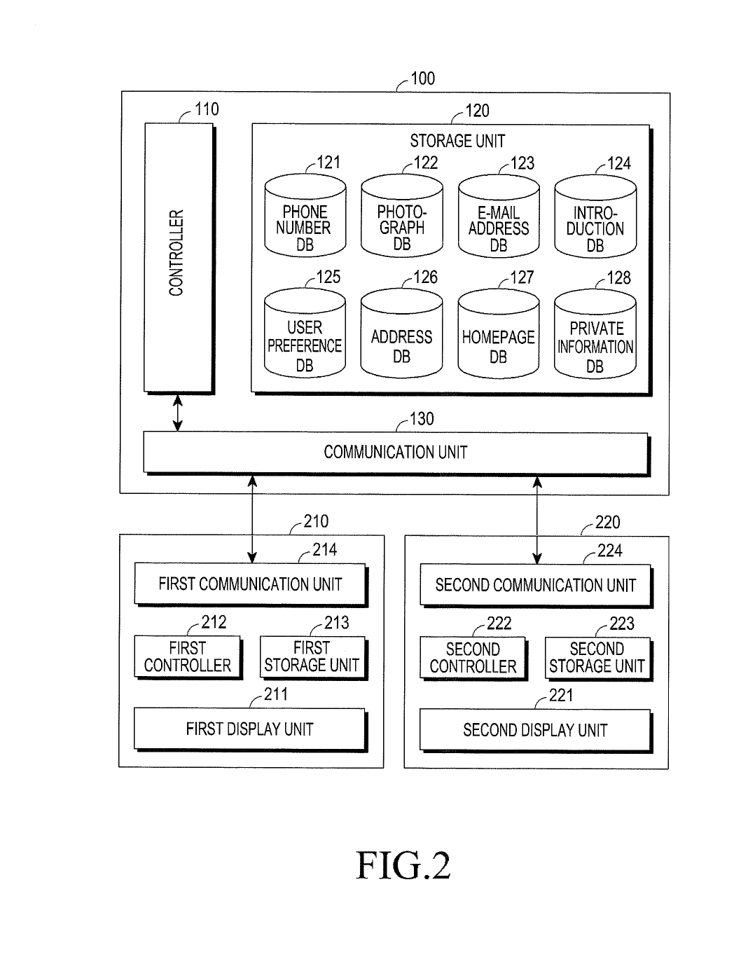

FIG. 2 is a high-level block diagram of a server according to one embodiment of the present disclosure. As illustrated in FIG. 2, the server 100 includes a controller 110, a storage unit 120, and a communication unit 130. The first terminal 210 includes a first display unit 211, a first controller 212, a first storage unit 213, and a first communication unit 214. The second terminal 220 includes a second display unit 221, a second controller 222, a second storage unit 223, and a second communication unit 224.

The controller 110 can control the entire operations of the server 100. The controller 110 can include a CPU, a ROM storing a control program, and a RAM storing signals or data input from the outside or being used as a storage area for a preformed operation. The CPU can include a single core processor, a dual core processor, a triple core processor, or a quad core processor. The CPU, ROM, and RAM can be interconnected via an internal bus.

The storage unit 120 can store a signal or data input/output according to the control of the controller. The storage unit 120 can store control programs or applications. The term “storage unit” includes a ROM or a RAM in a controller or a memory card (not illustrated) (for example, an SD card and a memory stick) equipped to a terminal. The storage unit can include a non-volatile memory, a volatile memory, a hard disc drive (HDD) or a solid state drive (SSD).

The storage unit 120 can store a phone number DB 121, a photograph DB 122, an e-mail address DB 123, an introduction DB 124, a user preference DB 125, an address DB 126, a homepage DB 127, and a private information DB 128.

The phone number DB 121 can store phone numbers assigned to the first terminal 210 and the second terminal 220. Otherwise, the phone number DB 121 can store telephone books stored in each of the first terminal 210 and the second terminal 220.

The photograph DB 122 can store photographs stored in the first terminal 210 and the second terminal 220. The photograph DB 122 can store all the photographs stored in the first terminal 210 and the second terminal 220. Otherwise, the photograph DB 122 can store photographs transmitted from the first terminal 210 and the second terminal 220.

The e-mail address DB 123 can store an e-mail address of the first user who uses the first terminal 210 and an e-mail address of the second user who uses the second terminal 220.

The introduction DB 124 can store introduction information received from the first terminal 210 and the second terminal 220. For example., the first user can input his/her own introduction to the first terminal 210, and the first terminal. 210 can transmit the input introduction to the server 100. The server 100 can store the received introduction in the introduction DB 124.

The user preference DB 125 can store preference information of the first user and the second user. Here, the user preference information can include fields in which the user is interested. For example, the user preference information can be determined by a user directly inputting keywords. Otherwise, the user preference information can be determined by homepages frequently visited by the user, search words frequently input, location information about frequently visited GPS coordinates, and the like.

The address DB 126 can store address information such as home addresses or office addresses of the first user and the second user.

A homepage address DB 127 can store home address information used by the first user and the second user.

The private information DB 128 can store phone number information stored in the first terminal 210 and the second terminal 220. Otherwise, the private information DB 128 can store the GPS location information and user identifications (ID) of the first terminal 210 and the second terminal 220.

The communication unit 130 can include at least one of a mobile communication module, a wireless LAN module, and a near field communication module.

The first and second display units 211 and 221 can display messages received by the first and second terminals 210 and 220. Otherwise, the first and second display units 211 and 221 can display data rendered by an application.

The first and second display units 211 and 221 can be implemented by an LCD module. Otherwise, the first and second display units 211 and 221 can be implemented by a touch screen. The touch screen can provide the user with a user interface corresponding to various services (for example, a telephone call, data transmission, broadcast, or capturing images). The touch screen can transmit analog signals corresponding to at least one touch input to the user interface to a touch screen controller. The touch screen can receive at least one touch through the body (for example, fingers including a thumb) of the user, or a touchable input means (for example, a stylus pen). Further, the touch screen can receive continuous movements of one touch among, at least one touch. The touch screen can transmit analog signals corresponding to the continuous movements of the received touch to the touch screen controller.

The touch in the present disclosure is not limited to contact on the touch screen with the body of the user or the touchable input means, or non-contact (the distance between the touch screen and the body of the user or the touchable input means being equal to or less than, for example, 1 mm). The detectable distance from the touch screen can be changed according to the performance or the structure of the terminal.

The touch screen can be implemented by, for example, a resistive scheme, a capacitive scheme, an infrared scheme, or an acoustic wave scheme.

The touch screen controller converts the analog signals received from the touch screen to digital signals (for example, X-Y coordinates) and transmits the converted digital signals to a controller. The controller can control the touch screen by using the digital signals received from the touch screen controller. For example, the controller can enable a short cut icon (not illustrated) displayed on the touch screen to be selected or execute the short cut icon (not illustrated) in response to the touch. Further, the touch screen controller can be included in the controller.

If the first and second display units 211 and 221 are implemented by the touch screen, the first and second display units 211 and 221 can be named as first and second input units, respectively.

The first and second controllers 212 and 222 can include a ROM or a RAM in a controller or a memory card (not illustrated) (for example, an SD card and a memory stick) equipped to a terminal. The CPU can include a single core processor, a dual core processor, a triple core processor, or a quad core processor. The CPU, ROM, and RAM can be interconnected via an internal bus.

The first and second storage units 213 and 223 can store signals or data input/output according to the control of each controller. The first and second storage units 213 and 223 can store control programs and applications. The term “storage unit” includes a ROM or a RAM in a controller or a memory card (not illustrated) (for example, an SD card and a memory stick) equipped to a terminal. The storage unit can include a non-volatile memory, a volatile memory, a hard disc drive (HDD) or a solid state drive (SSD).

The first and second communication units 214 and 224 enable the terminals to be connected to external devices through a mobile communication, in which each of the first and second communication units can use either one antenna or a plurality of antennas (not illustrated), under the control of the controllers thereof. The first and second communication units 214 and 224 receive/transmit wireless signals for voice communications, video communications, text messages (SMS), or multimedia messages (MMS) with a cellular phone (not illustrated), a smart phone (not illustrated), a tablet PC, or other devices (not illustrated). The first and second communication units 214 and 224 can be implemented, for example, by wireless communication modules.

Otherwise, the first and second communication units 214 and 224 can be implemented by sub-communication modules, or wireless LAN modules. If the first and second communication units 214 and 224 are implemented by sub-communication modules, the sub-communication modules each may include at least one of a wireless LAN module and a near field communication module. For example, a sub-communication module may include a wireless LAN module only, a near field communication module only, or both of a wireless LAN module and a near field communication module.

If the first and second communication units 214 and 224 are implemented by wireless LAN modules, the wireless LAN modules may be connected to the Internet by the control of the controller at a location where a wireless AP (access point) (not illustrated) is installed. The wireless LAN modules conforms with the wireless LAN standard (IEEE 802.11x) of Institute of Electrical and Electronics Engineers (IEEE). The near field communication module may wirelessly perform a near field communication between a terminal and an image forming apparatus (not illustrated) by the control of the controller. The near field communication scheme may include Bluetooth, infrared data association (IrDA,), and the like.

The first and second communication units 214 and 224 may include at least one of a wireless communication module, a wireless LAN module, and a near field communication module, and the like.

In the embodiment of FIG. 2, the first and second user is associated with each other. Here, the association can mean a state where the first user and the second user can transmit and receive messages to each other.

The first terminal 210 can store a part of the second user information, and the first and second users can be associated with each other using the stored part of the second user information. For example, it is assumed that the first user recognizes a phone number assigned to the second terminal 220 among the second user information. The first user can input the phone number assigned to the second terminal to the first terminal 210, and can request the server to associate the first user with the second user. The server 100 can associate the first terminal 210 and the second terminal 220 according to the request of the first terminal 210 or the second terminal 220. Otherwise, the server 100 can associate the first terminal 210 and the second terminal 220, when a part of the first user information received from the first terminal 210 is associated with the second user information. For example, when the first user information stores the phone number of the second user, the server 100 automatically associates the first terminal 210 and the second terminal 220.

The server 100 can provide a service such as a chatting session between the first terminal 210 and the second terminal 220 associated with each other.

Hereinafter, signal transmission and reception between the server 100, and the first and second terminals 210 and 220 will be described.

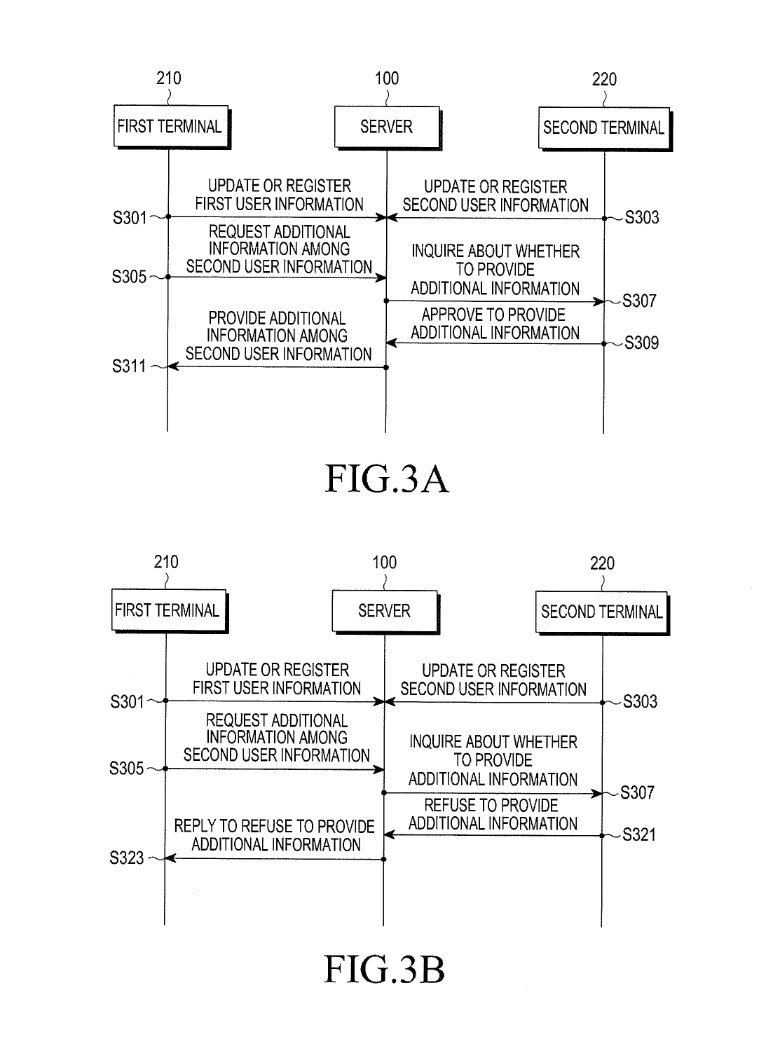

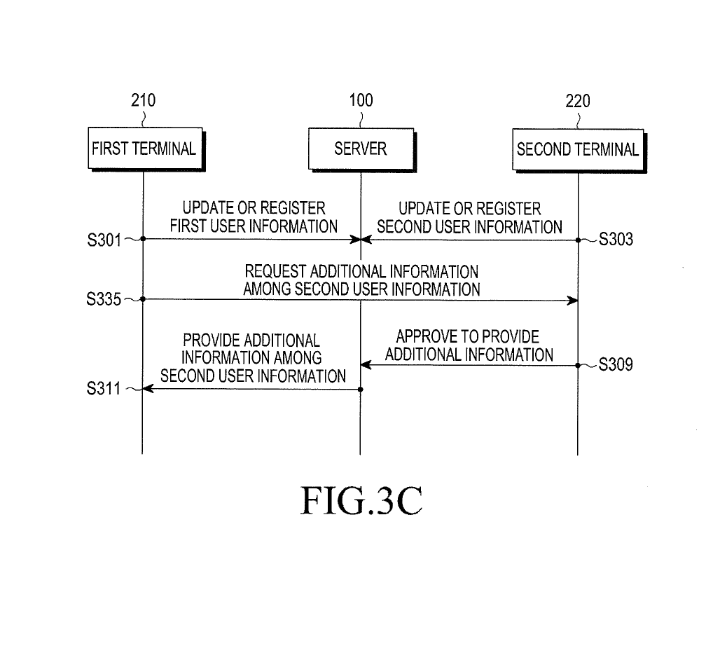

FIGS. 3A to 3C are signal flow diagrams illustrating operations of a server and terminals of the present disclosure.

The first terminal 210 can update or register the first user information to the server 100 (S301). The first terminal 210 can collectively register the first user information at the time of registering a specific service. In addition, the first terminal 210 can update the first user information by using a periodic or specific event as a trigger. In addition, the second terminal 220 can update or register the second user information to the server 100 (S303). For example, the first terminal 210 can periodically transmit GPS information to the server 100. Otherwise, the first terminal 210 can synchronize the stored telephone book with the server 100 at a specific time point. Otherwise, the first terminal 210 can transmit user information modified based on the modification input by the first user to the server 100.

Meanwhile, in the embodiment of FIG. 3A, it is assumed that only a part of the second user information is stored. The first temtinal 210 can transmit a request for the additional information which is not stored in the first terminal 210 among the second user information (S305). Here, the additional information message can include identification that identifies the second terminal 220.

The server 100 generates an inquiry concerning whether to provide additional information based on the received request for additional information and transmits it to the second terminal 220 (S307). The inquiry can include the identification of the first terminal 210, and a message indicating that the first user of the first terminal 210 requests to provide additional information of the second user.

The second terminal 220 can generate and transmit an approval message indicating the approval of the provision of additional information (S309). The server 100 can transmit the additional information of the second user stored in the DB of the storage unit 120 to the first terminal 210 (S311). Otherwise, the server 100 can collectively transmit the information of the second user stored in the DB of the storage unit 120 to the first terminal 210. The first terminal 210 can store received additional information of the second user, or all of the second user information.

As described above, the first terminal 210 can obtain additional information of the second user even when a part of the second user information is stored. In addition, since the additional information of the second user is provided with the first user only when the second user approves to provide the additional information, the user information security effect can be obtained. Further, since the second user information stored in the server 100 is provided, the inconvenience of the second user directly inputting additional information can be relieved.

FIG. 3B is a signal flow diagram illustrating a case in which the second user refuses to provide additional information. If the second user refuses to provide additional information, the second terminal 220 can transmit an refusal response to the first terminal (S321). The server 100 can transmit a message indicating that the second user refuses to provide additional information to the first terminal 210 (S323).

FIG. 3C is a signal flow diagram illustrating operations of a server and terminals according to another embodiment of the present disclosure. As illustrated in FIG. 3C, the first terminal 210 can directly transmit a request for additional information to the second terminal 220 (S335). That is, the first terminal 210 can transmit the request for additional information without involvement of the server 100.

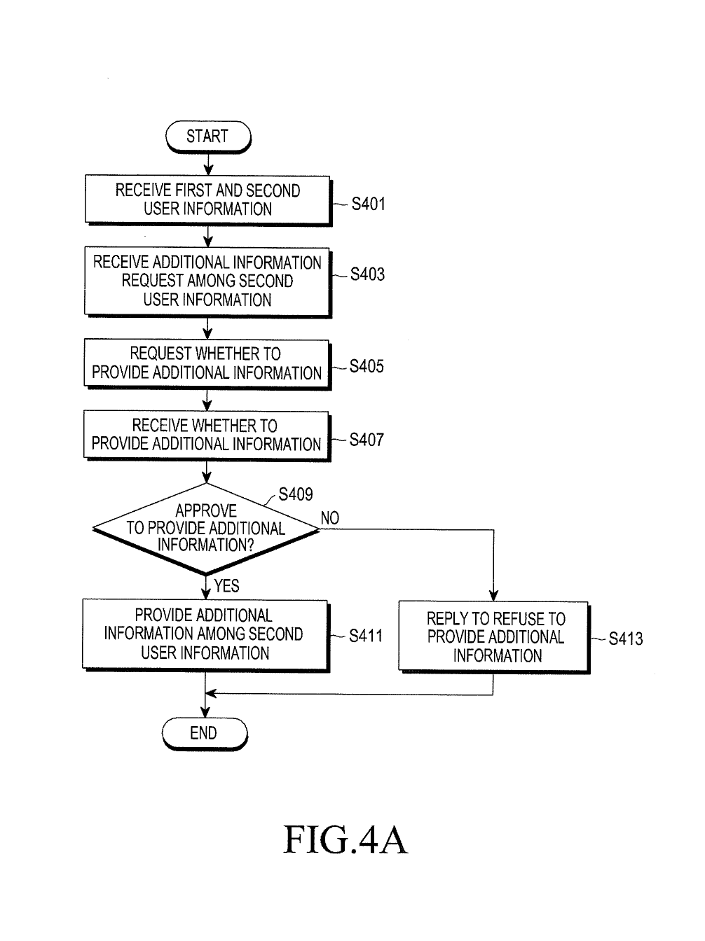

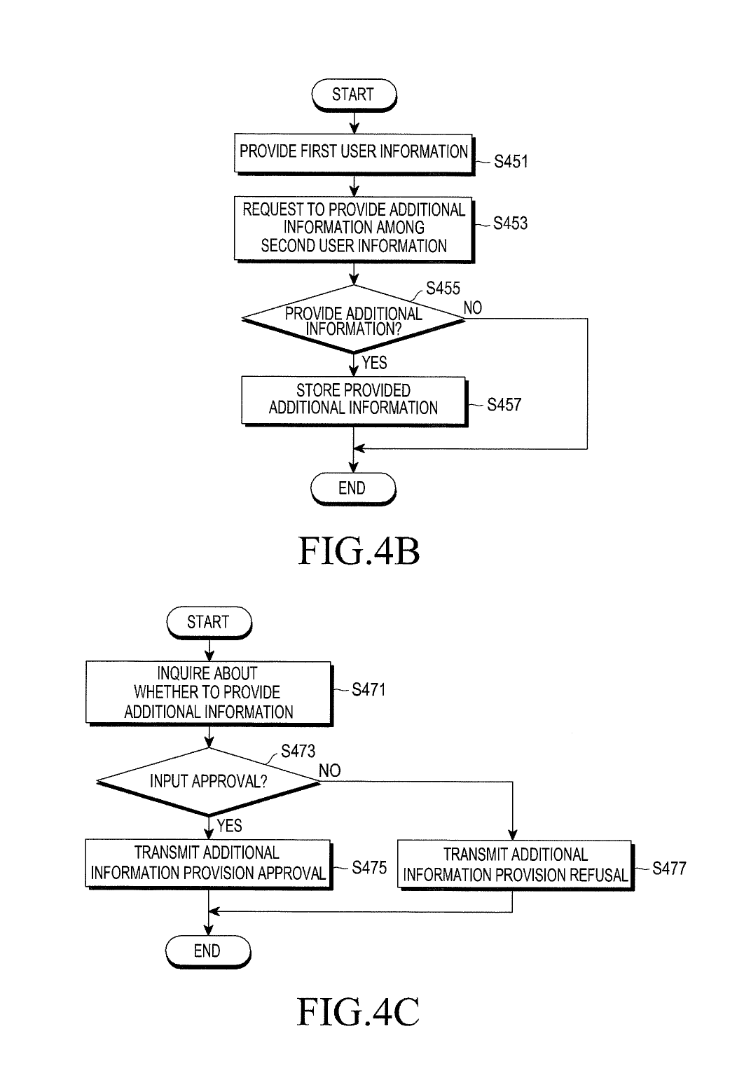

FIG. 4A is a flowchart illustrating an operation of a server of the present disclosure.

The server 100 can receive the first and second user information (S401). For example, the server 100 can receive the first and second user information when the first user and the second user are registered to a service. Otherwise, the server 100 can receive the first and second user information when the server 100 detects a periodic or predetermined event.

The server 100 can receive a request for additional information that requests additional information among the second user information from the first terminal 210 (S403). When the additional information request message is received, the server 100 can transmit an inquiry concerning approval/refusal for the request to the second terminal 220 (S405). The server 100 can receive whether to provide additional information from the second terminal 220 (S407).

The server 100 can determine whether the second user approves to provide additional information based on the received message about the provision of additional information (S409). When it is determined that the second user approves to provide additional information (Yes in S409), additional information among the second user information can be transmitted to the first terminal 210 (S411). Meanwhile, when it is determined that the second user refuses to provide additional information (No in S409), a message can be transmitted indicating that the second user refuses to provide additional information to the first terminal 210 (S413).

FIGS. 4B and 4C are flowcharts illustrating operations of the terminal of the present disclosure. Especially, FIG. 4B is a flowchart illustrating operations of the first terminal 210, and FIG. 4C is a flowchart illustrating operations of the second terminal 220.

The first terminal 210 can provide the server 100 with the first user information (S451). For example, the first terminal 210 can transmit the first user information to the server 100 when the first user is registered to a service. Otherwise, the first terminal 210 can transmit the first user information to the server 100 when the periodic or predetermined event is detected.

Meanwhile, the first terminal 210 can transmit a request for additional information that requests to provide additional information among the second user information based on the input by the first user (S453). Here, the first terminal 210 can transmit the request for additional information to the server 100, or directly transmit the additional information request message to the second terminal 220.

The first terminal 210 can receive or may not receive an additional message according to the additional information request message from the server 100 (S455). When the additional information is received from the server 100 (Yes in S455), the first terminal 210 can store the received additional information (S457).

The second terminal 220 can receive an additional information provision approval/refusal message from the server 100 or the first terminal 210 (S471).

When the second user approves to provide additional information (Yes in S473), the second terminal 220 transmits an approval message to the server 100 (S475). Meanwhile, when the second user does not approve to provide additional information (No in S473), the second terminal 220 transmits a refusal response to the server 100 (S477).

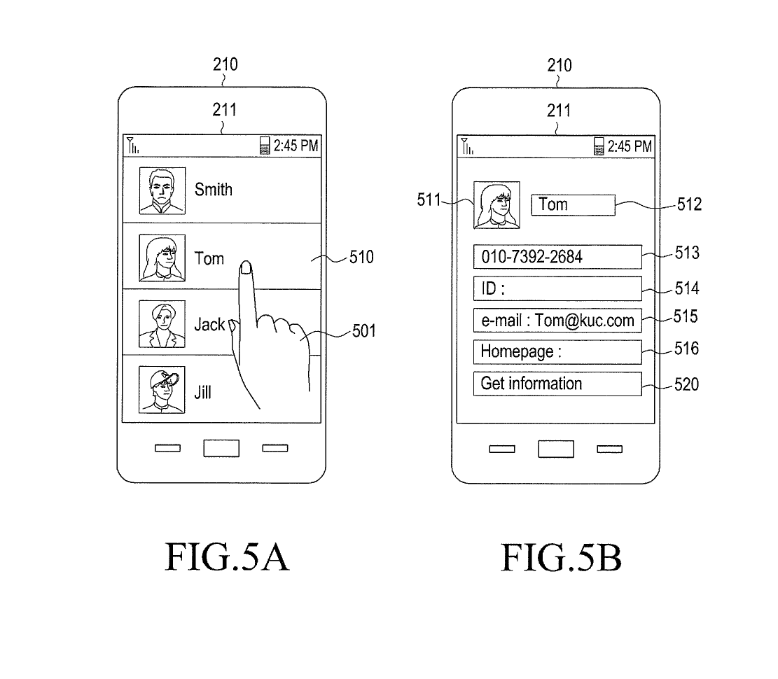

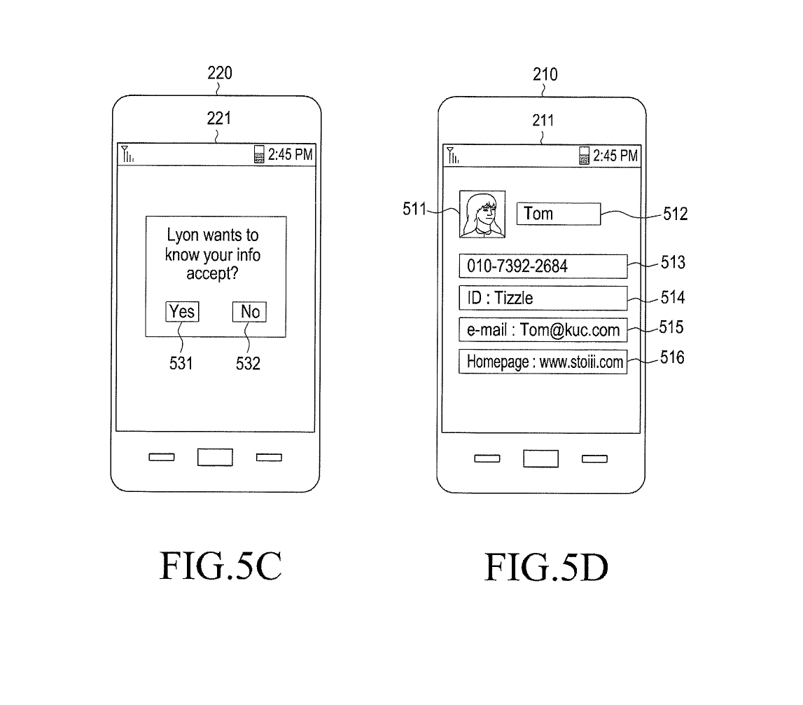

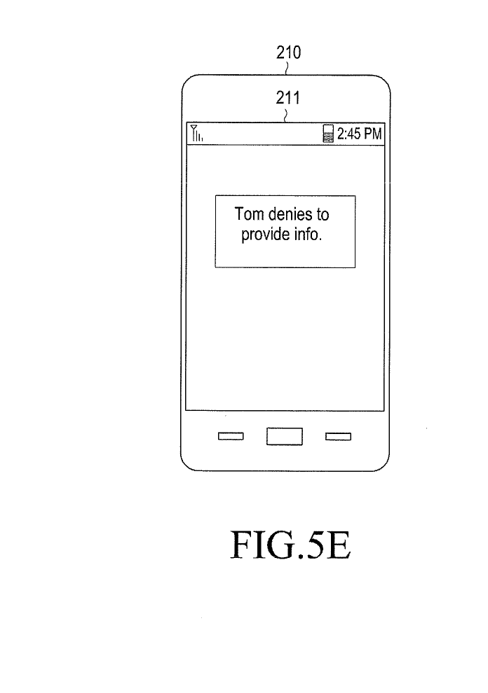

FIGS. 5A to 5E are diagrams illustrating concepts of the terminal according to an embodiment of the present disclosure.

The first terminal 210 of FIG. 5A includes the first display unit 211 implemented by a touch screen. On the first display unit 211, a related user list 510 relating to the first user can be displayed on the first display unit 211. The related user list 510 can include, for example, a photograph provided by the related user, and identification of the related user. The first user can designate the second user from the related user list 510 by using a finger 501 or a stylus pen. In the embodiment of FIG. 5A, the first user designates “Tom” as a second user.

FIG. 5B is a diagram illustrating an example screen after the first user designates the second user from the related user list 510. As illustrated in FIG. 5B, if the second user is designated, the first terminal 210 displays user information of the second user. More specifically, the first terminal 210 configures a rendering screen based on the second user information stored in the first storage unit 213. For example, it is assumed that the first storage unit 213 stores a photograph of the second user, a name of the second user, a phone number of the second user, and an e-mail address of the second user. Further, it is assumed that the first storage unit 213 does not store the identification of the second user or a homepage address of the second user. The first controller 212 reads the second user information stored in the first storage unit 213. The first controller 212 reads the second user information from the first storage unit 213. The resulting screen after the rendering can include a photograph display area 511 of the second user, a name display area 512 of the second user, a phone number display area 513 of the second user, an identification display area 514 of the second user, an e-mail address display area 515 of the second user, a homepage address display area 516 of the second user, and an additional information request area 520. Since the first storage unit 213 does not store the identification or the homepage address of the second user, it is confirmed that the second user the identification display area 514 and the second user the homepage address display area 516 in the second user information screen illustrated in FIG. 5B are displayed as blank. If the first user desires to obtain additional information of the second user, that is, the identification and the homepage address, the first user can designate the additional information request area 520 with a finger or a stylus pen. If the first user designates the additional information request area 520, the first terminal 210 can request additional information among the second user information to the server 100 or the second terminal 220. The processes described above correspond to step S305 in FIGS. 3A to 3C. The server 100 can request whether to provide additional information to the second terminal 220, and this can correspond to step S307 in FIG. 3A.

FIG. 5C is a diagram illustrating a concept of a screen of the second display unit 221 when the second terminal 220 receives an additional information provision approval/refusal request message. A message 530 indicating that the first user desires to obtain additional information among the second user information can be displayed on the second display unit 221. The message 530 can be displayed in the form of a pop-up or a dialogue. Otherwise, the second terminal 220 can display the message 530 when the user performs a corresponding service. The message 530 can include selection areas 531 and 532 that enable the second user to select whether to provide additional information. The second user can approve or refuse to provide the additional information to the first user by selecting one of the selection areas 531 and 532 that enables selection of whether to approve to provide additional information. If the second user designates the additional information provision approval selection area 531, the second terminal 220 transmits the additional information provision approval message to the server 100. In addition, if the second user designates the additional information provision refusal selection area 532, the second terminal 220 transmits the refusal response to the server 100. If the additional information provision approval message is received from the second terminal 220, the server 100 transmits the additional message among the second user information to the first terminal 210. Otherwise, the server 100 can transmit all of the second user information stored in the storage unit 120 to the first terminal 210.

FIG. 5D is a diagram illustrating a second user information screen displayed on the first terminal 210, after the additional information among the second user information or all of the second user information is received. In contrast to the second user information screen of FIG. 5B, the first terminal 210 of FIG. 5D displays identification of the second user and a homepage address of the second user on a second user identification display area 524 and a second user homepage address display area 526, respectively.

If the first terminal 210 receives additional information among the second user information from the server 100, the second user information screen can be rendered by combining the previously stored second user information and the received additional information. If the first terminal 210 receives all the second user information from the server 100, the first storage unit 213 is updated into new second user information. The first terminal 210 can render the second user information screen with the updated second user information.

Meanwhile, if the second user chooses the additional information provision refusal area 532, the second terminal 220 transmits the refusal message to the server 100. If the refusal message is received from the second terminal 220, the server 100 transmits a refusal message indicating that the second user refuses to provide additional information to the first terminal 210.

FIG. 5E is a diagram illustrating a screen when the first terminal 210 receives the refusal response from the server 100. As illustrated in FIG. 5E, the first terminal 210 can display a message indicating that the second user does not provide additional information on a display unit 211. Otherwise, the first terminal 210 can display a message indicating that the additional information of the second user is not stored in the server 100.

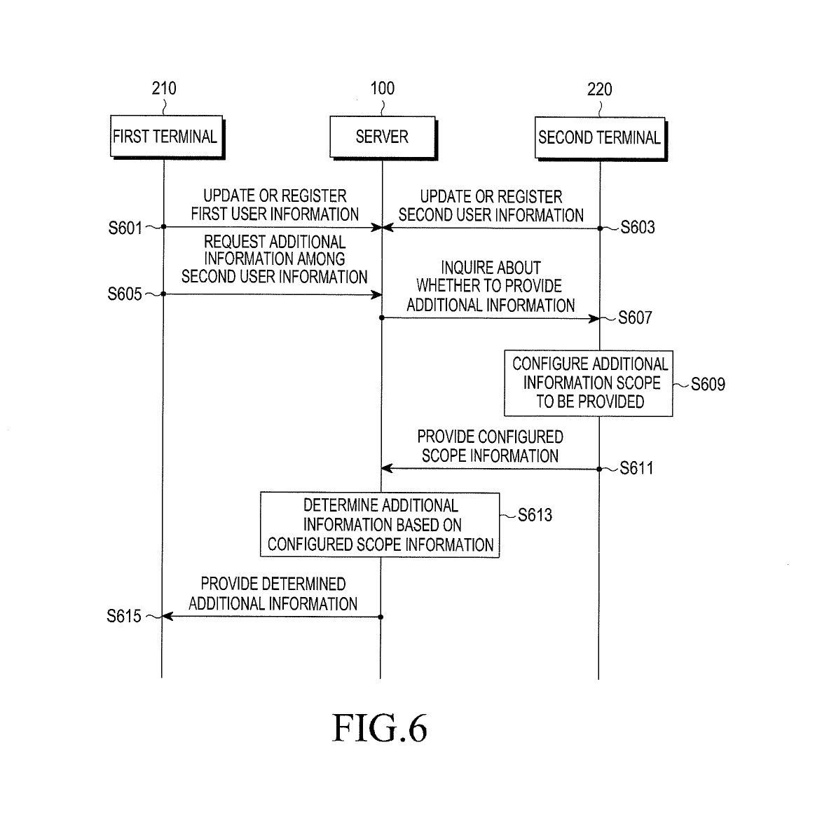

FIG. 6 is a signal flow diagram illustrating operations of the server and the terminals of the present disclosure.

The first terminal 210 can update or register the first user information to the server 100 (S601). The first terminal 210 can collectively register the first user information at the time of being registered to a specific service. Further, the first terminal 210 can update the first user information by using a periodic or specific event as a trigger. The second terminal 220 can update or register the second user information to the server 100 (S603). For example, the first terminal 210 can periodically transmit GPS information to the server 100. Otherwise, the first terminal 210 can synchronize the stored telephone book with the server 100 in every specific point. Otherwise, the first terminal 210 can transmit the modified user information based on the modification input by the first user to the server 100.

In the embodiment of FIG. 6, it is assumed that the first terminal 210 stores only a part of the second user information. The first terminal 210 can transmit a request for the additional information among the second user information to the server 100 (S605). Here, the additional information message can include identification that identifies the second terminal 220. Meanwhile, in another embodiment of the present disclosure, the first user can select additional information desired to be obtained, and input the selected additional information to the first terminal 210. For example, it is assumed that the first terminal 210 does not store identification, a homepage address, a telephone book, or address information among the second user information. The first user can perform input to provide only identification and a homepage address among the second user information. The first terminal 210 can display an interface that enables selection of additional information to request provision of, and can receive an input of the requested additional information from the first user.

The server 100 can transmit an inquiry concerning whether to provide the additional information based on the received request for additional information to the second terminal 220 (S607). The inquiry can include identification of the first terminal 210, and a message indicating that the first user of the first terminal 210 requests the second user to provide the additional information.

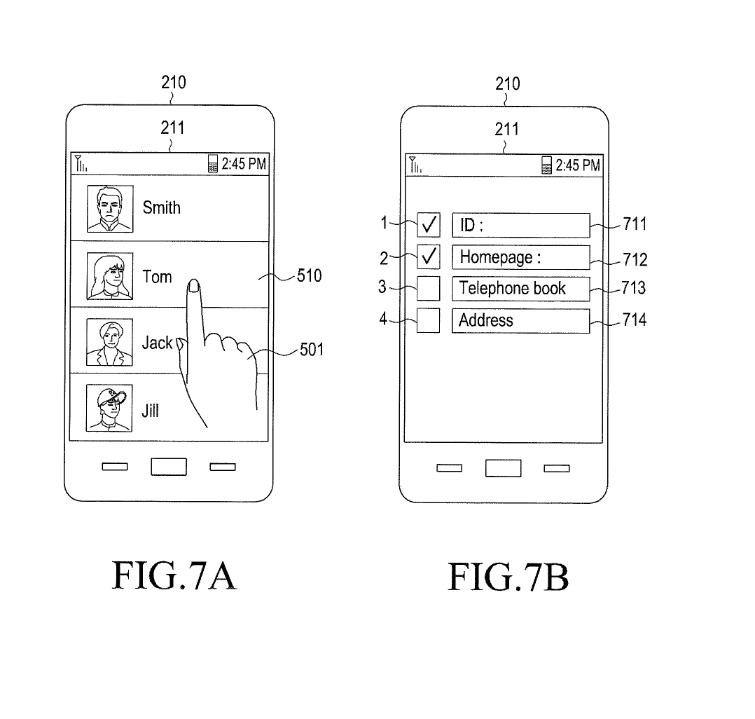

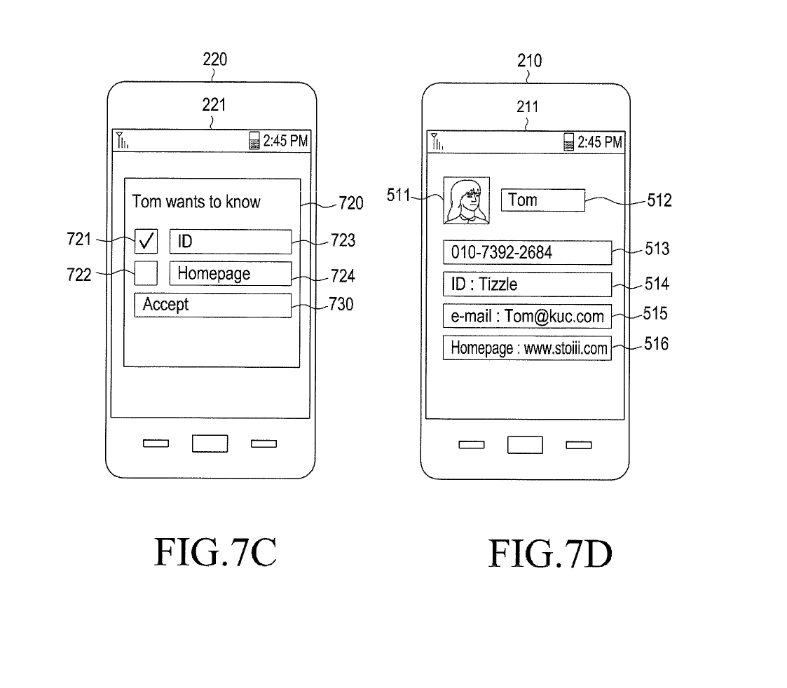

The second user can configure the scope of the additional information to be provided among the additional information of which provision is requested (S609). For example, if the first terminal 210 requests provision of the identification and the e-mail address of the second user, the second user can configure the scope to be provided among the identification and the e-mail address. For example, the second user can perform input to provide the identification only, or to provide the e-mail address only. The second terminal 220 can display an interface for the scope configuration of the additional information to be provided, and can receive an input of the scope configuration of the additional information provided by the second user. The interface for the scope configuration of the additional information to be provided which is displayed on the second terminal 220 will be described more specifically, with reference to FIGS. 7A to 7D.

The second terminal transmits a configured scope information message to the server 100 based on the provided scope configuration of the additional information input from the second user (S611).

The server 100 confirms the scope of the additional information which the second user approves to provide, by analyzing the received configured scope information message. Further, the server 100 determines an additional message to be transmitted to the first terminal 210 among the second user information based on the scope of the confirmed scope of the additional information (S613).

The server 100 transmits the additional information among the determined second user information (S615). The first terminal 210 can store the additional information among the received information of the second user.

As described above, the first user can obtain the additional information of the second user, even when a part of information among the second user information is recognized. Especially, since the second user can choose information to be provided among the information of the second user, the user information security effect can be obtained.

FIGS. 7A to 7D are diagrams illustrating concepts of the terminal according to an embodiment of the present disclosure.

FIG. 7A is a diagram illustrating a concept of a screen after the first user designates the second user from the related user list 510. As illustrated in FIG. 7A, if the second user is designated, the first terminal 210 displays the user information of the second user. More specifically, the first terminal 210 configures a rendering screen based on the second user information stored in the first storage unit 213. For example, it is assumed that the first storage unit 213 stores a photograph of the second user, a name of the second user, a phone number of the second user, and an e-mail address of the second user. Further, the first storage unit 213 does not store identification of the second user, a homepage address of the second user, a telephone book of the second user, or address information of the second user.

The first terminal 210 can display an interface that enables the first user to select additional information to request provision of the additional information. FIG. 7B is a diagram illustrating a concept of an interface displayed on the first terminal 210 according to an embodiment of the present disclosure. As illustrated in FIG. 7B, the first terminal 210 displays information which is not stored in the first storage unit 213 among the second user information. For example, the first terminal 210 displays an identification selection area 1, an identification display area 711, a homepage address selection area 2, a homepage address display area 712, a telephone book selection area 3, a telephone book display area 713, an address information selection area 4, and an address information display area 714. The first user can designate at least one of the identification selection area 1, the homepage address selection area 2, the telephone book selection area 3, and the address information selection area 4. The first terminal can determine additional information which is requested to be provided, based on the input of the user. In an embodiment of FIG. 7B, it is assumed that the first user selects the identification selection area 1 and the homepage address selection area 2. The first terminal 210 can transmit a request for additional information that requests provision of the identification and the homepage address of the second user, to the server 100. Meanwhile, the server 100 can transmit the received request for additional information to the second terminal 220. Of course, the first terminal 210 can directly transmit the additional information request message that requests provision of the identification and the homepage address of the second user, to the second terminal 220. Here, the request for additional information can be configured as a list of the additional information selected by the first user.

FIG. 7C is a screen of the second terminal 220. The second terminal 220 displays the additional information request message received from the first terminal 210 or the server 100. For example, the second terminal 220 analyzes the received request for additional information, so that the first user requests provision of the identification and the homepage address of the second user. The second terminal 220 provides an interface that enables the second user to select the additional information to be provided. The interface can display information and a selection area about the additional information which the first user requested provision of. For example, the interface displays an identification provision selection area 721, a homepage address provision selection area 722, an identification display area 723, a homepage address display area 724, and a provision approval area 730. The second user can designate an area of the interface to select the additional information to provide among the additional information requested to be provided. The second user can designate, for example, the identification provision selection area 721, and the provision approval area 730. The second terminal 220 can transmit the configured scope information message to provide only the identification among the additional information requested to be provided, based on the input of the second user, to the server 100. That is, the configured scope information message can be configured as a list of the additional information which the second user selects to provide.

The server 100 analyzes the input configured scope information message, and confirms that the second user approves to provide only the identification among the additional information requested to be provided. The server 100 transmits the identification information among the second user information to the first terminal 210.

The first terminal 210 updates and displays the second user information based on the received additional information. FIG. 7D is a diagram illustrating the updated second user information displayed by the first terminal 210 according to an embodiment of the present disclosure. As illustrated in FIG. 7D, “Tizzle”, which is the received identification of the second user, is displayed on the identification display area 514. Further, a homepage address of the second user is not displayed on the homepage address display area 516.

As illustrated above, the first user can select the additional information to request provision thereof, and the second user can also select the additional information to provide. Accordingly, the private information security effect can be obtained.

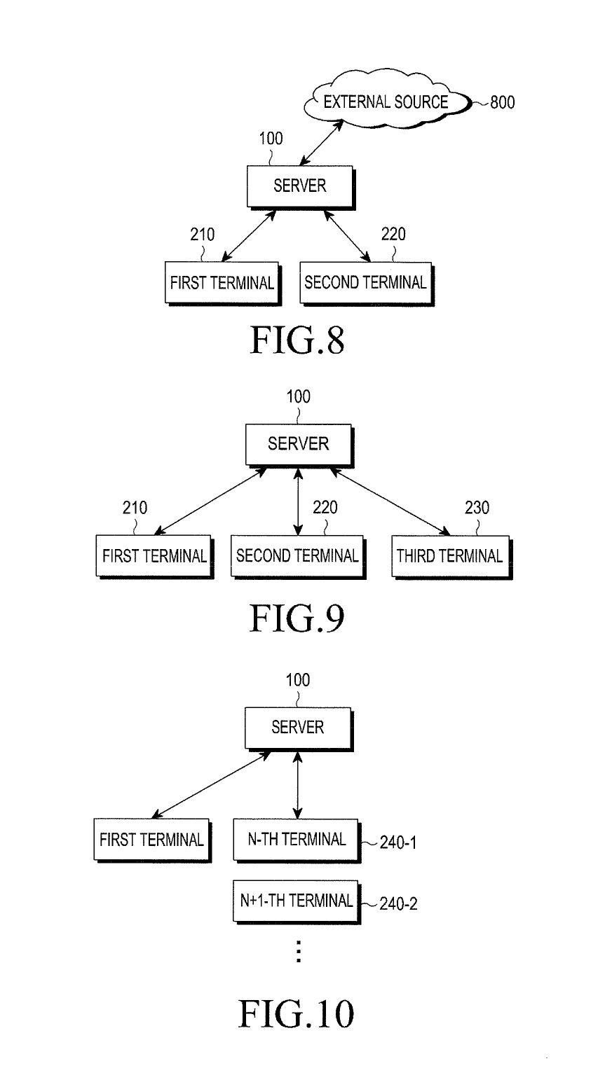

FIGS. 8 to 10 are block diagrams illustrating information reception and transmission between a server and terminals according to various embodiments of the present disclosure.

FIG. 8 is a diagram illustrating the server 100 that receives a DB stored in the storage unit 120 from an external source 800. The server 1100 receives the first user information and the second user information from the first terminal 210 and the second terminal 220. Further, the server 100 can receive the first user information and the second user information from the external source 800.

The server 100 may store phone numbers recorded on the homepage of the user as user information. For example, it is assumed that the first user registers the homepage address of the first user to the server 100, but does not register the phone number of the first user. The server 100 can store a phone number recorded on the homepage address registered by the first user as a phone number of the first user.

The server 100 can store messenger state information of the user on the user preference DB 125. If the user uses the terminal in association with a messenger, messenger state information, for example, state information such as “absent”, and a user written message such as a profile, is stored in the user preference DB 125.

The server 100 may receive a user photograph from a phonebook photograph support server associated with the phone number of the terminal. The server 100 may store the photograph received from the phonebook photograph support server in the photograph DB 122. Otherwise, the server 100 may periodically perform a web-search. For example, the server 100 may perform the web-search by using the identification of the user as a search word, and may store photographs searched as a result of performing the web-search in the photograph DB 122.

The server 100 may receive DMB content viewing information of the terminal and store the information in the user preference DB 125. For example, the server 100 may receive DMB content viewing time information and channel information from the terminal, and may extract keywords or the like based on the corresponding viewing time and channel information. The server 100 may store the extracted keywords and a name of the corresponding content in the user preference DB 125.

The server 100 may update the user preference DB 125 by the periodic web-search. For example, the server 100 may perform the web-search based on the stored user information. The server 100 may update the user preference DB 125 based on the result of the performed web-search.

As described above, the server 100 may update the user information according to various schemes.

FIG. 9 is a block diagram illustrating operations when the first terminal does not store even a part of information among information of a specific user. For example, it is assumed that the first terminal 210 is associated with the second terminal 220 while the first terminal 210 and a third terminal 230 are not associated with the second terminal 220. That is, the first terminal 210 does not store the user information of the third terminal 230. Meanwhile, it is assumed that the second terminal 220 stores user information of the third terminal 230. For example, the second terminal 220 stores a phone number of the third terminal 230 in the telephone book.

The first terminal 210 may request the third terminal 230 to provide the user information based on the telephone book of the second terminal 220. The first terminal 210 requests the server 100 to provide, for example, the user information for users corresponding to all of the phone numbers stored in the second terminal 220. The server 100 transmits a message indicating that the first user requests provision of the user information of all of the phone numbers stored in the second terminal 220. For example, if the third terminal 230 is registered to a service, the server 100 directly transmits a user information provision request message to the third terminal 230. If the third terminal 230 is not registered to the service, the server 100 transmits the user information provision request message in the form of a text message.

The third terminal 230 transmits the user information provision approval message or the user information provision refusal message to the server 100 based on the input of the third user. Then, the server 100 transmits the third user information to the first terminal 210.

Meanwhile, if the third terminal 230 is not registered to the service, the third terminal 230 transmits the third user information to the server 100. The server 100 stores the received third user information in the storage unit 120. Then, the server 100 transmits the third user information to the first terminal 210.

As described above, if the first terminal 210 does not recognize the user information of the third terminal 230, the first terminal 210 may obtain the third user information.

FIG. 10 is a block diagram illustrating an operation in which the first terminal requests all terminals registered to the service to provide user information.

The first terminal 210 may request all the terminals registered to the service, such as n-th terminal 240-1, and n+1-th terminal 240-2 to provide user information. More specifically, the first terminal 210 transmits a user information provision request message that requests provision of user information of all the terminals registered to the service, to the server 100. The server 100 transmits user information provision request messages to all the terminals 240-1, 240-2, and the like. The server 100 receives user information provision approval messages or user information provision refusal messages from all the terminals 240-1, 240-2, and the like registered to the service. The server 100 transmits the user information corresponding to terminals that have transmitted the user information provision approval messages to the first terminal 210.

Especially, the first terminal 210 may transmit user information provision request messages to terminals existing within a certain distance from the first terminal 210, based on GPS information.

As described above, the first terminal 210 may obtain user information from all registered terminals.

It will be understood that embodiments of the present disclosure may be implemented by hardware, software, or the combination of hardware and software. The optional software may be stored in a volatile or non-volatile storage unit such as a ROM, a memory such as a RAM, a memory chip, or an integrated circuit, an optically or magnetically recordable and machine-readable (for example, computer-readable) storage unit such as a CD, a DVD, a magnetic disc, or a magnetic tape, regardless of erasability or re-writability. A method of updating a graphic screen may be implemented by a computer or a portable device including a controller or a memory, and the memory is an example of a machine-readable storage medium appropriate for storing a program or programs including instructions to implement embodiments of the present disclosure. Accordingly, the present disclosure includes programs including codes to implement apparatuses or methods described in any claims of the present disclosure or a machine-readable (for example, computer-readable) storage medium storing the programs. Further, such programs may be electronically transmitted via optional media such as a communication signal transmitted by wire or wirelessly, and the present disclosure appropriately includes the equivalents thereof.

In addition, the terminal or the server may receive the programs from a program providing apparatus connected by wire or wirelessly, and may store the program. The terminal or the server may include a memory for storing programs including instructions that enable the terminal or the server to perform predetermined content protection methods, information required for the content protection methods, or the like, a communication unit for performing wired or wireless communications with the graphic processing apparatus, and a controller for transmitting the corresponding programs to the transmitting and receiving apparatuses automatically or under the request of the graphic processing apparatus.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of operating a server managing user information, the server communicating with a first terminal and a second terminal, the method comprising:
receiving a request for additional information of a second user, the additional information being not stored in the first terminal;
transmitting an inquiry concerning whether to provide the additional information to the second user terminal;
receiving a response to the inquiry from the second terminal; and
determining whether to transmit the additional information stored in the server to the first terminal, based on the response to the approval request.

2. The method according to claim 1, further comprising:
transmitting the additional information to the first terminal if an approval response to the inquiry is received from the second terminal.

3. The method according to claim 1, further comprising:
transmitting a notice indicating refusal of providing the additional information to the first terminal if an rejection response to the inquiry is received from the second terminal.

4. The method according to claim 1, wherein the first user information and the second user information comprise at least one of a phone number, a telephone book, a photograph, an e-mail address, introduction information, user preference information, address information, homepage address information, and private information with respect to each of the first user and the second user.

5. The method according to claim 1, further comprising:
receiving first and second user information from each of the first and second terminals.

6. The method according to claim 5, wherein receiving the first and second user information from each of the first and second terminals is performed periodically.

7. The method according to claim 5, wherein receiving the first and second user information from each of the first and second terminals is performed if the predetermined event is detected.

8. The method according to claim 5, wherein receiving the first and second user information from each of the first and second terminals is performed when each of the first terminal and the second terminal is registered to a service managed by the server.

9. The method according to claim 1, further comprising:
receiving the first and second user information from an external source.

10. The method according to claim 9, wherein the external source is at least one of a messenger server associated with the first and second terminals, a phonebook photograph support server, a homepage of the first user and the second user, or web-search.

11. The method according to claim 1, wherein the additional information to be requested is selected by the first user.

12. The method according to claim 1, wherein the second user configures a list containing additional information to be provided to the server in response to the request for additional information.

13. A method of operating a first terminal registered to an information management service provided by a server, the method comprising:
transmitting a request for additional information of a second user, the additional information being not stored in the first terminal; and
receiving the additional information stored in the server from the server.

14. The method according to claim 13, further comprising:
displaying an interface screen that enables a first user to select additional information to be requested.

15. The method according to claim 14, further comprising:
receiving an input of selecting the additional information to request to be provided from the user.

16. The method according to claim 15, wherein the additional information provision request message is configured from an additional information list of which provision is requested.

17. A method of operating a second terminal registered to an information management service provided by a server, comprising:
receiving an inquiry concerning whether to provide additional information which is not stored in the first terminal among the second user information, from the server;
receiving an input in response to the inquiry from a user; and
transmitting, a response to the inquiry to the server based on the user input.

18. The method according to claim 17, further comprising:
displaying an interface that enables the user to select additional information to provide among the additional information.

19. The method according to claim 18, wherein receiving the input in response to the inquiry the further comprises receiving a selection of the additional information to provide.

20. A method of operating a server managing user information, the server communicating with a first user terminal and second user terminal, the method comprising:
receiving a request for additional information of a second user, the additional information being is not stored in the first terminal, from the second terminal; and
determining whether to transmit the additional information stored in the server to the first terminal based on a response from the second user terminal.

21. A server for managing user information, communicating with a first terminal and second user terminal, the server comprising:
a storage unit configured to store the first user information and the second user information;
a communication unit configured to receive an request for additional information, the additional information being not stored in the first terminal, from the first terminal; and
a controller configured to generate an inquiry concerning whether to provide the additional information to the first user and control the communication unit to transmit the inquiry to the second tell final,
wherein the communication unit is configured to receive a response for the inquiry, and the controller is configured to determine whether to transmit the additional information stored in the storage unit to the first terminal based on the response to the inquiry.

22. The server according to claim 21, wherein if the response to inquiry contains an approval, the controller is configured to control the communication unit to transmit the additional information to the first user tell final.

23. The server according to claim 21, wherein if the response to inquiry contains a refusal, the controller is configured to control the communication unit to transmit a notice of refusal to the first user terminal.

24. The server according to claim 21, wherein the user information comprises at least one of a phone number, a telephone book, a photograph, an e-mail address, introduction information, user preference information, address information, homepage address information, and private information with respect to each of a user.

25. The server according to claim 21, wherein the communication unit is configured to receive the user information from each of user terminal.

26. The server according to claim 25, wherein the controller periodically is configured to receive the first and second user information from each of the first and second terminals.

27. The server according to claim 25, wherein the controller is configured to control the communication unit to receive the first and second user information from each of the first and second test finals if a predetermined event is detected.

28. The server according to claim 25, wherein the controller is configured to control the communication unit to receive the first and second user information from each of the first and second terminals when each of the first terminal and the second terminal is registered to a service managed by the server.

29. The server according to claim 21, wherein the controller is configured to control the communication unit to receive the first and second user information from an external source.

30. The server according to claim 29, wherein the external source is at least one of a messenger server associated with the first and second terminals, a phonebook photograph support server, a homepage of the first user and the second user, or a web-search.

31. The server according to claim 21, wherein a first user selects an additional information list to request.

32. The server according to claim 21, wherein the second user configures a list containing additional information to be provided to the server in response to the request for the additional information.

33. A terminal registered to an information management service provided by a server, the terminal comprising:
a controller configured to generate a request for additional information, the additional information being not stored in the first to urinal; and
a communication unit configured to transmit the request for the additional information and receive the additional information stored in the server from the server.

34. The terminal according to claim 33, further comprising:
a display unit configured to display an interface screen that enables a user to select additional information to request.

35. The terminal according to claim 34, further comprising:
an input unit configured to receive an input of selecting the additional information to request from the user.

36. The terminal according to claim 35, wherein the request for the additional information is configured from an additional information list.

37. A terminal registered to an information management service provided by a server, the terminal comprising:
a communication unit configured to receive an inquiry concerning whether to provide additional information to a first terminal from the server;
an input unit configured to receive an input in response to the inquiry from the user; and
a controller configured to generate a response to the inquiry based on the received input, and control the communication unit to transmit the response to the inquiry to the server.

38. The terminal according to claim 37, further comprising:
a display unit configured to display an interface that enables a user to select additional information to provide.

39. The terminal according to claim 38, wherein the input unit further receives an input of selecting the additional information to provide.

40. A server for managing user information using information, the server communicating with a first and a second terminals, the server comprising:
a communication unit configured to receive a response to an inquiry concerning whether to provide the first terminal with additional information that is not stored in the first terminal from the second terminal; and
a controller configured to determine whether to transmit the additional information stored in the server to the first terminal based on the response to the inquiry.
